(19) United States
(12) Patent Application Publication
(10) Pub. No.: US 2009/0266801 A1
(43) Pub. Date: Oct. 29, 2009

(54) METHOD OF LASER WELDING METAL PLATED PLATES

(75) Inventors: Yoshihiro Oku, Ota-shi (JP); Taichi Shimizu, Midori-shi (JP); Kenichi Kawamata, Ota-shi (JP)

Correspondence Address: MORRISON & FOERSTER LLP, 1650 TYSONS BOULEVARD, SUITE 400, MCLEAN, VA, 22102, US

(73) Assignee: TOA Industries Co., Ltd., Ohta-shi (JP)

(21) Appl. No.: 12/208,953

(22) Filed: Sep. 11, 2008

(30) Foreign Application Priority Data
Apr. 24, 2008 (JP) 2008-113803

(51) Int. Cl. B23K 26/00

(52) U.S. Cl. 219/121.64

(57) ABSTRACT

The invention provides a method of laser welding zinc plated steel plates which surely realizes excellent welding without a melting defect such as blowholes. By irradiating a line on a superposed portion of a lower plate and an upper plate with a first laser beam having a high energy density and a small irradiation region by moving the first laser beam therealong, steel plate portions in the small irradiation region are melted and zinc on the superposed surfaces around the small irradiation region including in the small irradiation region is evaporated and allowed to escape outside. Then, after the irradiation with the first laser beam, the same line is irradiated with a second laser beam having a lower energy density than the first laser beam and a larger irradiation region than the first laser beam by moving the second laser beam therealong to melt steel plate portions in the larger irradiation region, thereby completing weldbonding.

### CROSS-REFERENCE OF THE INVENTION

This application claims priority from Japanese Patent Application No. 2008-113803, the content of which is incorporated herein by reference in its entirety.

### BACKGROUND OF THE INVENTION

1. Field of the Invention

The invention relates to a method of laser welding a superposed portion of a plurality of metal plated plates.

2. Description of the Related Art

A zinc plated steel plate is a steel plate material formed by plating zinc for rust proofing on a surface of a steel plate as a base metal plate, and often used as a structural material for a body of an automobile or the like. For forming the body or the like, a laser welding method is known in which two zinc plated steel plates are superposed and the superposed portion is irradiated with a laser beam to melt and bond the steel plate materials (see Japanese Patent Application Publication Nos. Hei 4-231190, Hei 10-156566 and 2002-178178).

When this laser welding is performed, it is known that a welding defect occurs due to a lower boiling point (about 900° C.) of zinc than a melting point (about 1500° C.) of the steel plate (iron). In detail, by irradiating the superposed portion with a laser beam, the steel plate is melted but zinc on the superposed surfaces is evaporated at this time. Zinc vapor then rushes outside through the melted steel plates. As a result, a portion of the melted steel plates is blown off or some zinc vapor remains inside the steel plates to form pores called blowholes, thereby degrading welding strength and appearance.

From this viewpoint, various countermeasures are proposed for a method of laser welding zinc plated steel plates (see Japanese Patent Application Publication Nos. Hei 4-231190, Hei 10-156566 and 2002-178178). For example, Japanese Patent Application Publication No. Hei 4-231190 describes a method in which zinc is first evaporated and dispersed with a laser beam having a low energy density and plates are then weldbonded with a laser beam having a high energy density.

In the welding method of Japanese Patent Application Publication No. Hei 4-231190, however, when zinc is evaporated and dispersed by the irradiation with the laser beam having the low energy density, almost all zinc vapor rushes outside only through a gap between the superposed surfaces of the steel plates. Therefore, zinc removal is likely to be insufficient.

An objective of the invention is to provide a method of laser welding zinc plated steel plates which surely realizes excellent welding without a melting defect such as blowholes or the like.

### SUMMARY OF THE INVENTION

The invention provides a method of laser welding. The method includes providing a first and a second metal plated plate each including a base metal plate and a metal plating formed on the base metal plate and having a melting point lower than the melting point of the base metal plate, and placing the first metal plated plate on the second metal plated plate so that at least part of the first metal plated plate is superposed on the second metal plated plate such that at least one of the metal plating is disposed between the two base metal plates. The method also includes irradiating a superposed portion of the first and second metal plated plates with a first laser beam along a welding line so as to melt the base metal plates and to evaporate the metal plating disposed between the two base metal plates. The first laser beam forms a first irradiation region on the superposed portion in which the base metal plates are melted and has a high energy density enough to evaporate the metal plating disposed between two non-melted base metal plates outside the first irradiation region, and the first irradiation region travels along the welding line as the superposed portion is irradiated along the welding line. The method further includes irradiating, after the irradiation with the first laser beam, the superposed portion of the first and second metal plated plates with a second laser beam along the welding line so as to melt the base metal plates. The second laser beam forms a second irradiation region on the superposed portion that is larger than the first irradiation region so that the base metal plates are melted in the second irradiation region and has a second energy density that is lower than the first energy density, and the second irradiation region travels along the welding line as the superposed portion is irradiated along the welding line.

### BRIEF DESCRIPTION OF THE DRAWINGS

FIG. 1 is a view showing a structure of a laser processing device of an embodiment of the invention.

FIGS. 2A to 2D are a perspective view and cross-sectional views for explaining a method of laser welding zinc plated steel plates of the embodiment of the invention.

FIGS. 3A and 3B are a perspective view and a cross-sectional view for explaining the method of laser welding zinc plated steel plates of the embodiment of the invention.

FIG. 4 is a plan view showing a region to be irradiated with a laser beam.

FIG. 5 is a perspective view for explaining the method of laser welding zinc plated steel plates of the embodiment of the invention.

FIG. 6 is a perspective view for explaining the method of laser welding zinc plated steel plates of the embodiment of the invention.

### DETAILED DESCRIPTION OF THE INVENTION

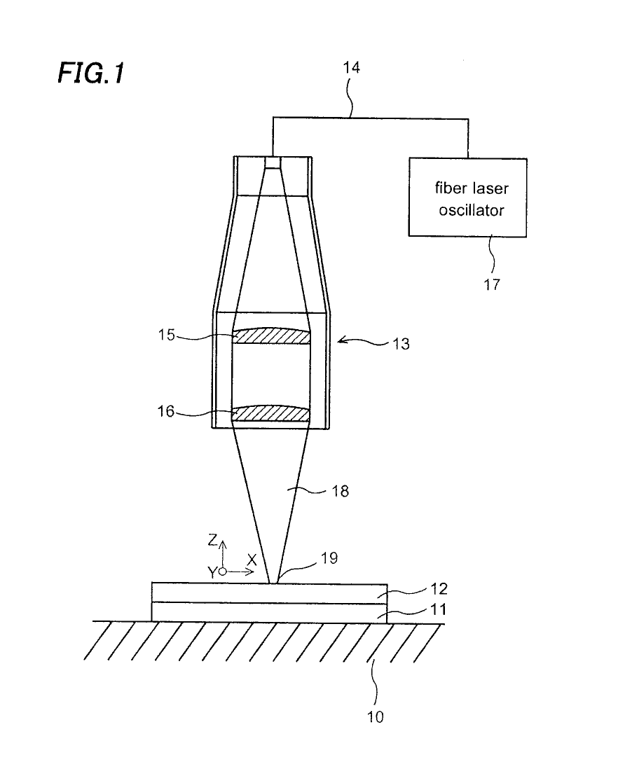

An embodiment of the invention will be described, hereafter. First, a structure of a laser processing device will be described referring to FIG. 1. As shown in the figure, two zinc plated steel plates which are superposed are mounted on a laser processing table 10. Hereafter, the zinc plated steel plate on the lower side is referred to as a lower plate 11, and the zinc plated steel plate on the upper side is referred to as an upper plate 12. It is preferable to fix the lower plate 11 and the upper plate 12 with a jig so that the superposed portions of the two plates are tightly in contact with each other.

A laser processing head 13 is placed above the laser processing table 10 where the lower plate 11 and the upper plate 12 are mounted, and a laser beam generated by a fiber laser oscillator 17 is outputted to this laser processing head 13 through an optical fiber 14. It is noted that a laser oscillator of other type such as a YAG laser oscillator, a CO₂ laser oscillator or the like may be used instead of the fiber laser oscillator 17.

The laser processing head 13 accommodates a collimation lens 15 and a condenser lens 16. A laser beam from the fiber laser oscillator 17 is converted to parallel rays by the collimation lens 15 first, and these parallel rays are condensed to a position at a given focal length by the condenser lens 16. The laser processing head 13 is movable in the X and Y directions on the upper plate 12 and in the Z direction vertical to the surface of the upper plate 12 by moving means such as, for example, a laser processing robot.

Therefore, the size of an irradiation region 19 (forming a circular region when seen from the vertical direction to the upper plate 12) of a laser beam 18 outputted from the laser processing head 13 is changed by moving the laser processing head 13 in the Z direction. The energy density of the laser beam 18 is energy per unit area of the irradiation region 19a, and when the output of the fiber laser oscillator 17 is constant, the energy density of the laser beam 18 is inversely proportional to the area of the irradiation region 19a.

Furthermore, the size of the irradiation region 19 is also changed by changing the collimation lens 15 or the condenser lens 16 in the laser processing head 13. Furthermore, by moving the laser processing head 13 in the X direction or the Y direction, or in the X and Y directions simultaneously, the irradiation region 19 of the laser beam 18 is moved on the superposed portion along a given line at a desired moving speed.

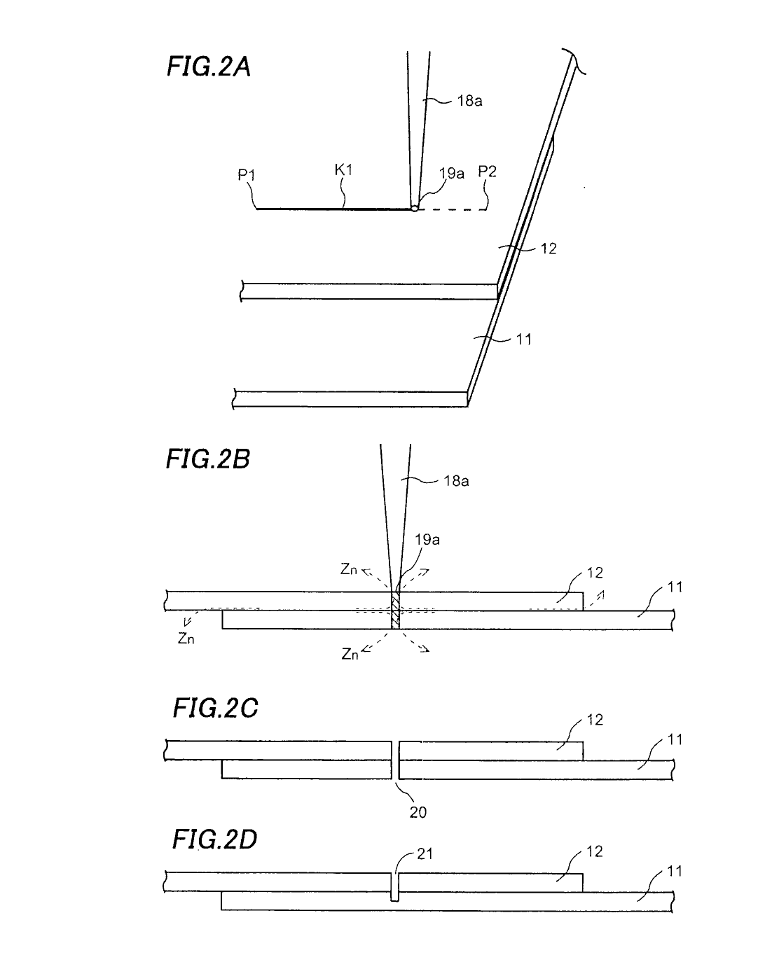

Hereafter, a method of laser welding zinc plated steel plates using the above described laser processing device will be described. First, as shown in a perspective view of FIG. 2A, the superposed portion of the lower plate 11 and the upper plate 12 is irradiated with a first laser beam 18a having a high energy density and a small irradiation region 19a by having the first laser beam 18a travel along a line K1 from a start point P1 to an end point P2 on the superposed portion of the lower plate 11 and the upper plate 12. The first laser beam 18a has a higher energy density and a smaller irradiation region 19a than a general welding laser beam.

By this process, as shown in a cross-sectional view of FIG. 2B, the steel plate portions (the base metal portions) of the lower plate 11 and the upper plate 12 in the small irradiation region 19a are melted. At this time, zinc existing on the superposed surfaces of the lower plate 11 and the upper plate 12 in the small irradiation region 19a and therearound is evaporated and escapes outside.

In detail, since the steel plate portions around the small irradiation region 19a, which are not melted, are also heated by the first laser beam 18a, zinc vapor occurs from a larger region of the superposed surfaces than the small irradiation region 19a. This zinc vapor escapes outside through the melted steel plate portions and also through the gap between the lower plate 11 and the upper plate 12 in the superposed portion.

At this time, since the zinc vapor escapes outside through the melted steel plate portions, a part of the melted steel plates or all the melted steel plates is blown off by pressure of the zinc vapor or forms blowholes, resulting in a welding defect. In the invention, however, such a welding defect occurs only in the small irradiation region 19a by the irradiation with the first laser beam 18a having a high energy density. It means that a region where the welding defect occurs is minimized and zinc in the larger region than this region is removed.

For allowing the zinc vapor to escape outside effectively, it is preferable that the energy density of the first laser beam 18a is so high as to form a penetration hole 20 penetrating both the lower plate 11 and the upper plate 12 by blowing off the melted steel plates in the small irradiation region 19a as shown in FIG. 2C. Even if the energy density of the first laser beam 18a is not so high and forms a penetration hole 21 penetrating the upper plate 12 and terminating in the middle of the thickness of the lower plate 11 as shown in FIG. 2D, the zinc vapor escapes effectively in some degree.

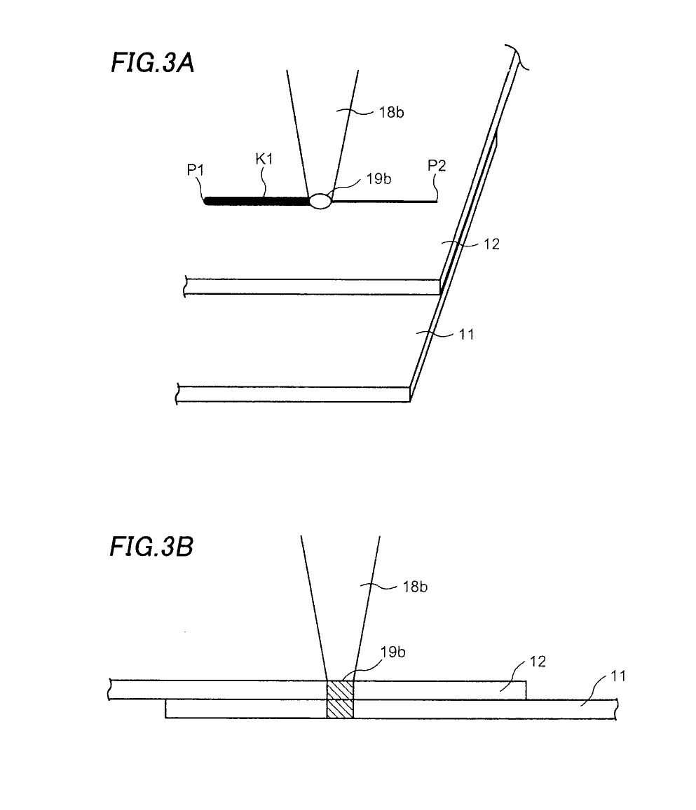

After the first laser beam 18a is moved along the line K1 from the start point P1 to the end point P2 as described above, the same line K1 is again irradiated with a second laser beam 18b having a lower energy density and a larger irradiation region 19b than the first laser beam 18a by moving the beam 18b therealong as shown in FIG. 3A.

At this time, the second laser beam 18b may be returned to the start point P1 and moved to the end point P2 again or may be started from the end point P2 and moved back to the start point P1. Although the second laser beam 18b has a lower energy density than the first laser beam 18a, it has the same energy density as a general welding laser beam. It means that the second laser beam 18b is a general welding laser beam.

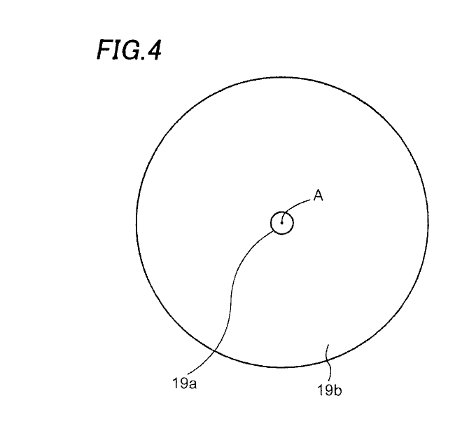

The whole small irradiation region 19a of the first laser beam 18a is included in the large irradiation region 19b. It is preferable that the small irradiation region 19a and the large irradiation region 19b form concentric circles sharing a center A when these are superposed (see FIG. 4). Furthermore, by the irradiation with the first laser beam 18a, zinc on the superposed surfaces in the large irradiation region 19b is already removed. The steel plate portions of the lower plate 11 and the upper plate 12 in the larger irradiation region 19b are melted in this manner, completing weldbonding.

At this time, since there hardly exists zinc in the large irradiation region 19b for welding, zinc evaporation does not occur and the welding defect (blowing off of the steel material, the penetration holes 20, 21 and the like) formed in the small irradiation region 19a, which occurs by the irradiation with the first laser beam 18a, is repaired. At this time, the steel plate portions on the sidewall of the penetration hole 20 or 21 are melted and the melted steel plate portions fill the penetration hole 20 or 21, thereby repairing the penetration hole 20 or 21 back into the original steel plate portions. Excellent weldbonding having high welding strength and good appearance is thus obtained (see a cross-sectional view of FIG. 3B).

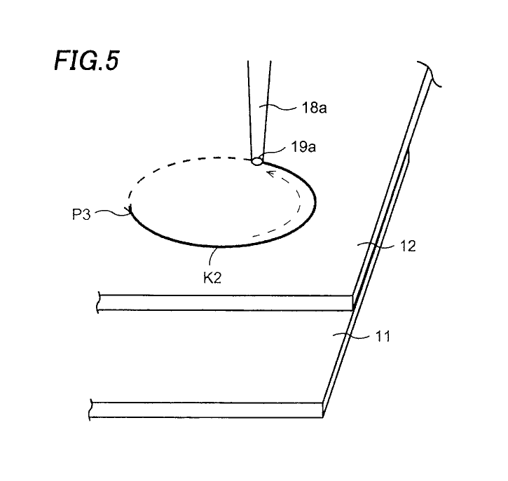

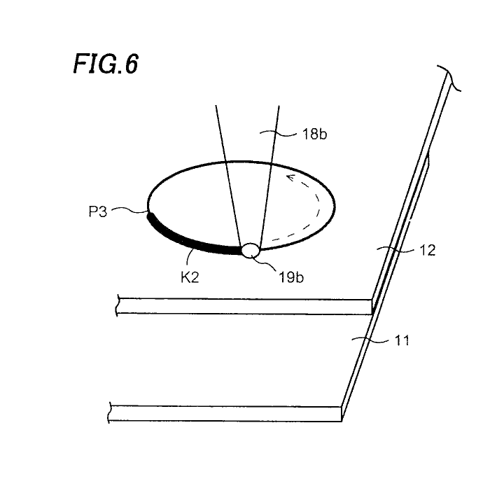

Although the line K1 along which the first laser beam 18a and the second laser beam 18b move is shown as a straight line, the invention is not limited to this and any line is applicable. For example, a circular line K2 as shown in FIGS. 5 and 6 is also applicable. In this case, as shown in FIG. 5, the first laser beam 18a is first moved along the line K2 from a start point P3 and moved back to the start point P3, and then the second laser beam 18b is moved along the line K2 from the start point P3 again to the start point P3 as shown in FIG. 6.

Although the laser welding is performed with the two zinc plated steel plates being superposed in the above described embodiment, the invention is also applicable to a case of laser welding with three or more zinc plated steel plates being superposed. Furthermore, the metal plated plate for the laser welding of the invention is not limited to the zinc plated steel plate, and may also be a metal plated plate formed by plating metal having a lower boiling point than a melting point of the steel plate, for example, aluminum or tin on the front surface of the steel plate. Furthermore, the material of the base metal plate is not limited to iron, and an alloy of iron and other element is also applicable, for example.

Hereafter, a detailed example of the invention will be described. Two zinc plated steel plates (standard: GAC270 t1.2) are prepared. This zinc plated steel plate is 1.2 mm in thickness, and 40 g/m² of zinc is plated on the front and back surfaces thereof. Then, the circular line K2 on the superposed portion of the two zinc plated steel plates is irradiated with the first laser beam 18a by moving the beam 18a therealong. The oscillation output of the fiber laser oscillator 17 at this time is 4 KW (kilowatt), the small irradiation region 19a of the first laser beam 18a is circular, and its diameter is 0.05 to 0.1 mm. The type number of the laser processing device used in this example is YLR1000 manufactured by IPG Photonics.

After the irradiation with the first laser beam 18a, the same line K2 is irradiated with the second laser beam 18b by moving the beam 18b therealong. The oscillation output of the fiber laser oscillator 17 at this time is 4 KW, the large irradiation region 19b of the second laser beam 18b is circular, and its diameter is 0.8 mm.

Since the oscillation output of the fiber laser oscillator 17 is constant at 4 KW, the energy density of the laser beam is inversely proportional to the area of the irradiation region. In the case of this embodiment, when the diameter of the small irradiation region 19a of the first laser beam 18a is 0.05 mm and the diameter of the larger irradiation region 19b of the second laser beam 18b is 0.8 mm, the energy density of the second laser beam 18b is about 3.9% of the energy density of the first laser beam 18a.

It is found that the irradiation with the first and second laser beams 18a and 18b realizes the welding of the two zinc plated steel plates along the line K2 with high welding strength and good appearance. The method of laser welding zinc plated steel plates in this example surely realizes excellent welding without a melting defect such as blowholes.

What is claimed is:

1. A method of laser welding, comprising:
providing a first metal plated plate and a second metal plated plate each comprising a base metal plate and a metal plating formed on the base metal plate and having a melting point lower than a melting point of the base metal plate;
placing the first metal plated plate on the second metal plated plate so that at least part of the first metal plated plate is superposed on the second metal plated plate such that at least one of the metal platings is disposed between the two base metal plates;
irradiating a superposed portion of the first and second metal plated plates with a first laser beam along a welding line so as to melt the base metal plates and to evaporate the metal plating disposed between the two base metal plates, the first laser beam forming a first irradiation region on the superposed portion in which the base metal plates are melted and having a first energy density so as to evaporate the metal plating disposed between two non-melted base metal plates outside the first irradiation region, and the first irradiation region traveling along the welding line as the superposed portion is irradiated along the welding line; and
irradiating, after the irradiation with the first laser beam, the superposed portion of the first and second metal plated plates with a second laser beam along the welding line so as to melt the base metal plates, the second laser beam forming a second irradiation region on the superposed portion that is larger than the first irradiation region so that the base metal plates are melted in the second irradiation region and having a second energy density that is lower than the first energy density, and the second irradiation region traveling along the welding line as the superposed portion is irradiated along the welding line.

2. The method of claim 1, wherein the first irradiation region and the second irradiation region form concentric circles.

3. The method of claim 1, wherein the first energy density is high enough to form a penetration hole penetrating the metal plated plates in the superposed portion by blowing off the melted base metal plates in the first irradiation region with a metal vapor generated by the irradiation with the first laser beam.

4. The method of claim 3, wherein the irradiation with the second laser beam melts base metal plates at a sidewall of the penetration hole so as to fill the penetration hole.

5. The method of claim 1, wherein the base metal plates comprise a steel and the metal platings comprise zinc or aluminum.
